(19) United States
(12) Patent Application Publication
(10) Pub. No.: US 2014/0212240 A1
(43) Pub. Date: Jul. 31, 2014

(54) FASTENING ASSEMBLY

(71) Applicant: FULL MOST CO., LTD., New Taipei City (TW)

(72) Inventors: Ming-Chun WENG, New Taipei City (TW); Ming-Tsang YU, New Taipei City (TW); Wen-Pin PEN, New Taipei City (TW)

(73) Assignee: FULL MOST CO., LTD., New Taipei City (TW)

(21) Appl. No.: 13/830,824

(22) Filed: Mar. 14, 2013

(30) Foreign Application Priority Data
Jan. 26, 2013 (TW) 102103060

(51) Int. Cl. F16B 39/24

(52) U.S. Cl. CPC F16B 39/24
USPC 411/145

(57) ABSTRACT

A fastening assembly includes a fastening screw and a fastening assembly. The fastening screw includes a head section having multiple first tooth elements at a lower surface thereof, and a screw fastening section at a lower portion thereof for fastening into a work piece. The fastening accessory includes multiple second and third tooth elements at upper and lower surfaces thereof, respectively, multiple grooves formed between the second tooth elements, and an embedding recess at an upper portion thereof. The fastening accessory is accommodated at a lower portion of the fastening screw to lodge the first tooth elements into the embedding recess, such that the fastening accessory is closely fastened to the lower portion of the fastening screw. The third tooth elements are engaged to a surface of the work piece to allow both of the fastening screw and the fastening accessory to become closely fastened to the work piece.

### BACKGROUND OF THE INVENTION

a) Field of the Invention

The invention relates in general to a fastening assembly, and more particularly to a fastening assembly for fastening to a work piece with a dual fastening effect provided by a fastening screw and a fastening accessory of the fastening assembly.

b) Description of the Related Art

Conventional screw nails and screw bolts are prevalent for fastening work pieces. For example, when fastening a screw nail or a screw bolt into a screw hole of a work piece, a fastening force between the screw nail or the screw bolt and the work piece is limited to only an occlusal force between a thread of the screw nail or the screw bolt and a thread in the screw hole. In the event of a collapse of either of the threads of the screw nail or the screw bolt or the screw hole, the fastening stability between the screw nail or the screw bolt and the work piece is degraded to result in issues of the screw nail or the screw bolt disengaging from the screw hole.

Further, in a fastening process of the conventional screw nail or screw bolt, to reinforce the fastening effect between the screw nail or the screw bolt and the work piece, a fastening accessory such as a washer or a nut is utilized in conjunction with the screw nail or the screw bolt. Nonetheless, the fastening force provided by the conventional washer or the nut coordinating with the screw nail or the screw bolt is still originated from the fastening force between the screw nail or the screw bolt and the screw hole of the work piece. That is to say, the washer or the nut does not actively provide a connecting force therefrom with the screw nail or the screw bolt. Consequently, a close connection between the screw nail or the screw bolt and the washer or the nut may not be achieved to severely jeopardize the fastening stability between the screw nail or the screw bolt and the work piece,

### SUMMARY OF THE INVENTION

A primary object of the present invention is provide a fastening assembly for eliminating issues of insufficient fastening stability and fastening force resulted from fastening solely utilizing a conventional screw nail or screw bolt, or resulted from a washer or a nut coordinating with a screw nail or a screw bolt.

To achieve the above object, a fastening assembly is provided by the present invention. The fastening assembly at least comprises a fastening screw and a fastening accessory. The fastening screw comprises a head section having a plurality of first tooth section formed at a lower surface of the head section, and a screw fastening section at a lower portion thereof for fastening into a work piece. The fastening accessory respectively comprises a plurality of second tooth elements and a plurality of third tooth elements at upper and lower surfaces thereof. A plurality of grooves are formed between the second tooth elements. The fastening accessory further comprises an embedding recess at an upper portion thereof. The fastening accessory is accommodated around the lower portion of the screw fastening section, such that the first tooth elements of the fastening screw are correspondingly lodged into the embedding recess at the upper portion of the fastening accessory, thereby closely fastening the fastening accessory to the lower portion of the fastening screw. Further, the third tooth elements of the fastening accessory are engaged with a surface of the work piece to allow both of the fastening screw and the fastening accessory to closely fasten to the work piece, thus forming a fastening assembly having a dual fastening effect.

The fastening assembly of the present invention offers reinforced fastening effects. By correspondingly lodging the first tooth elements at the lower surface of the head section of the fastening screw into the embedding recess at the upper portion of the fastening accessory, as well as engaging the third tooth elements at the lower surface of the fastening accessory into the surface of the work piece, a close fastening effect is provided between the fastening screw and the fastening accessory. Further, by respectively fastening the fastening screw and the fastening accessory to an interior and an upper surface of the work piece, a dual fastening effect is provided. As such, the fastening effect and fastening stability with respect to the fastened work piece is not degraded even in the event of a thread collapse of the fastening screw. Meanwhile, the fastening screw may also be independently screwed into the interior of the work piece to provide the work piece with a fastening effect. Further, a dual fastening effect can be formed by engaging the first tooth elements to the upper surface of the work piece.

The above and other aspects of the invention will become better understood with regard to the following detailed description of the preferred but non-limiting embodiments. The following description is made with reference to the accompanying drawings.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a fastening screw of a fastening assembly according to a first embodiment of the present invention.

FIG. 2 is a bottom view of FIG. 1.

FIG. 3 is an elevational view of a fastening accessory of a fastening assembly of the present invention.

FIG. 4 is an elevational view of a fastening accessory of a fastening assembly of the present invention from another angle.

FIG. 5 is a side view of a fastening accessory of a fastening assembly of the present invention.

FIG. 6 is a fastening screw of a fastening assembly according to a second embodiment of the present invention.

FIG. 7 is a first application example of a fastening assembly of the present invention.

FIG. 8 is a second application example of a fastening assembly of the present invention.

FIG. 9 is a third application example of a fastening assembly of the present invention.

FIG. 9A is an enlarged partial side view of a disengaging socket wrench downwardly pressing a fastening assembly in FIG. 9.

FIG. 10 is a side view of a disengaging socket wrench rotating in an opposite direction for removing a fastening screw in FIG. 9.

### DETAILED DESCRIPTION OF THE INVENTION

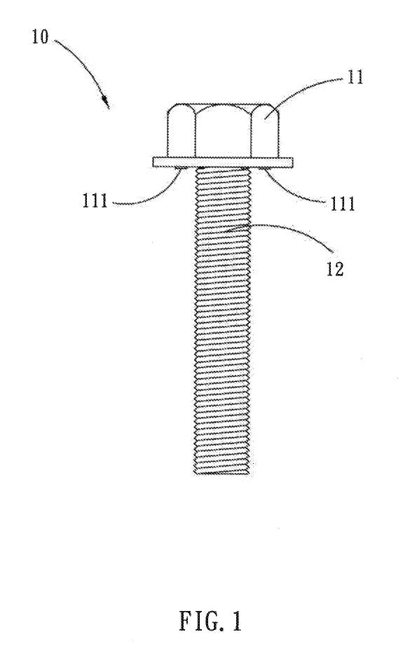

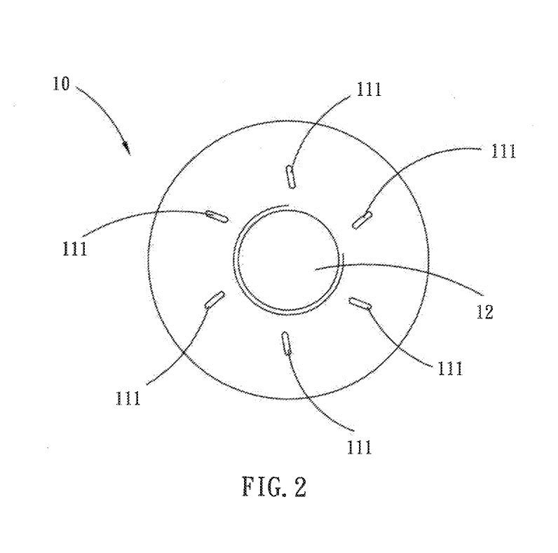

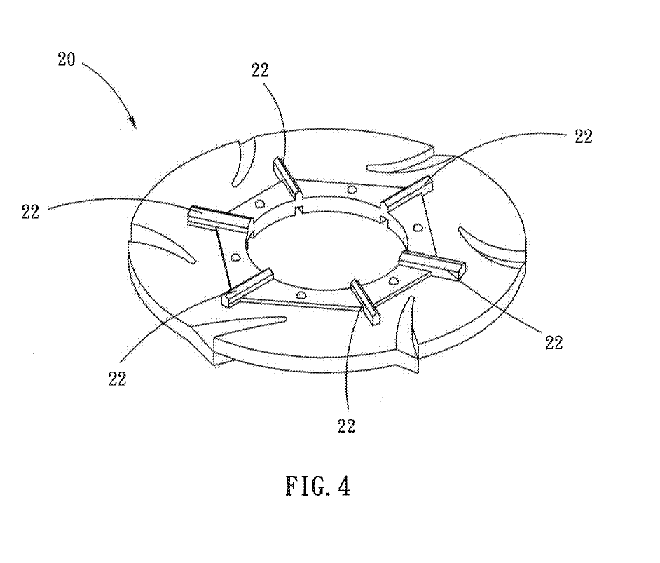

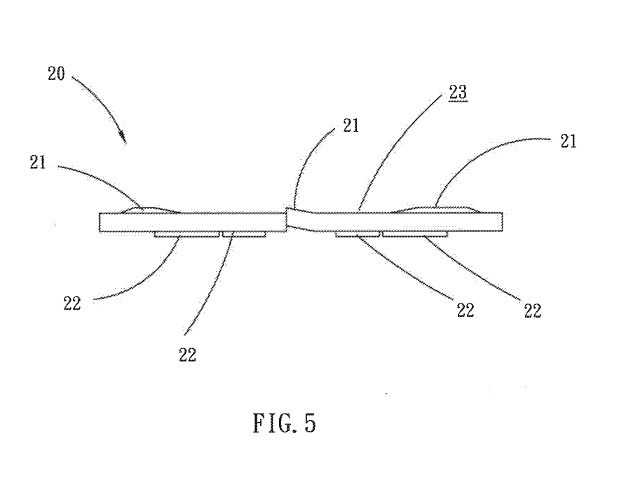

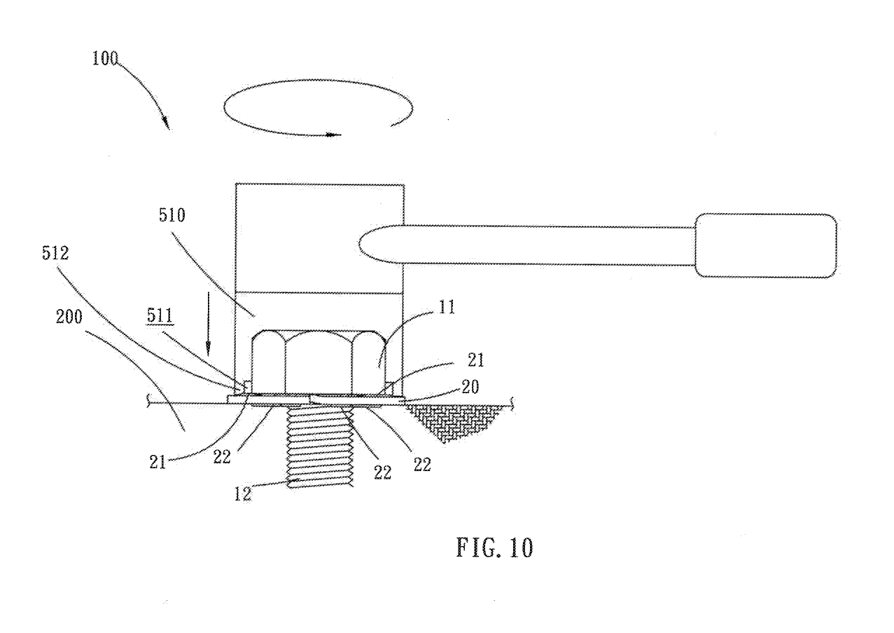

FIGS. 1, 2, 3, 4, 5, 6 and 7 show a first embodiment of the present invention. Referring to FIGS. 1 to 7, a fastening assembly 100 (in FIG. 10) according to the first embodiment comprises at least one fastening screw 10 and at least one fastening accessory 20. The fastening screw 10 has a head section 11, which is provided with a plurality of first tooth elements 111 (as shown in FIGS. 1 and 2) at a lower surface thereof. The first tooth elements 111 can be in various forms. In this embodiment, the first tooth elements 111 are exemplified by one-directional thorn teeth. In other embodiments, the first tooth elements 111 may also be implemented by other equivalent protruding tooth elements including rectangular blocks, protruding grains and protruding columns, as such modifications are also encompassed within the scope of the present invention. A lower portion of the fastening screw 10 is formed with a screw fastening section 12 as a screw rod having a plurality of threads.

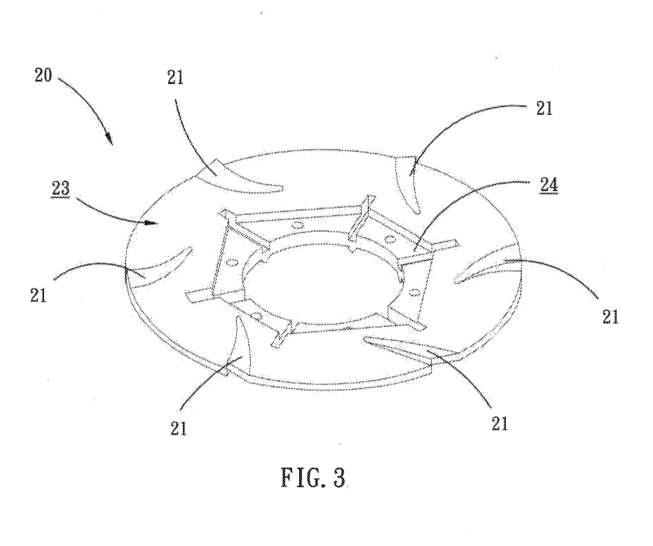

The fastening accessory 20 comprises a plurality of second tooth elements 21 and a plurality of third tooth elements 22 at upper and lower surfaces thereof (as shown in FIGS. 3, 4 and 5), respectively. The second tooth elements 21 and the third tooth elements 22 can be in various forms. In this embodiment, for example, the second tooth elements 21 and the third tooth elements 22 are exemplified by one-directional thorn teeth. A plurality of grooves 23 are formed between the second tooth elements 21. The second tooth elements 21 and the grooves 23 can be formed by various approaches. In this embodiment, for example, spaces between the second tooth elements 21 and the grooves 23 may be formed by a stamping fracture process. The fastening accessory 20 is accommodated around the screw fastening section 12 at the lower portion of the fastening screw 10. The fastening accessory 20 comprises an embedding recess 24 at an upper portion thereof for embedding the head section 11 of the fastening screw 10 therein, such that the first tooth elements 111 of the head section 11 are correspondingly lodged into the embedding recess 24, thereby closely fastening the fastening accessory 20 at a lower part of the head section 11 of the fastening screw 10. The fastening accessory 20 may be in various forms. In this embodiment, the fastening accessory 20 is exemplified by a washer.

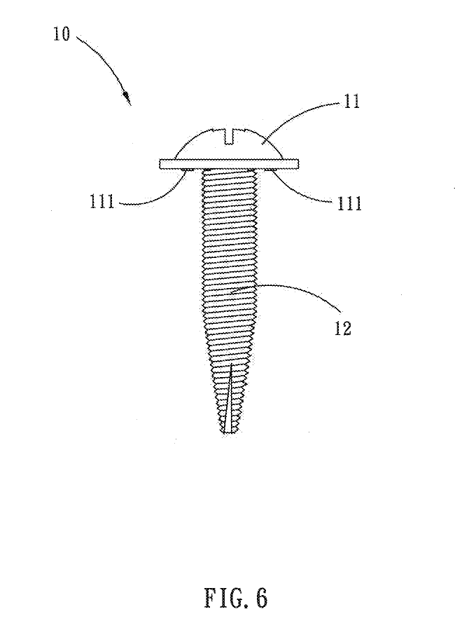

Referring to FIG. 6 showing the fastening assembly 100 (as shown in FIG. 10) according to a second embodiment of the present invention, the screw fastening section 12 at the lower portion of the fastening screw 10 is a pointed self-tapping screw rod for self-tapping fastening applications.

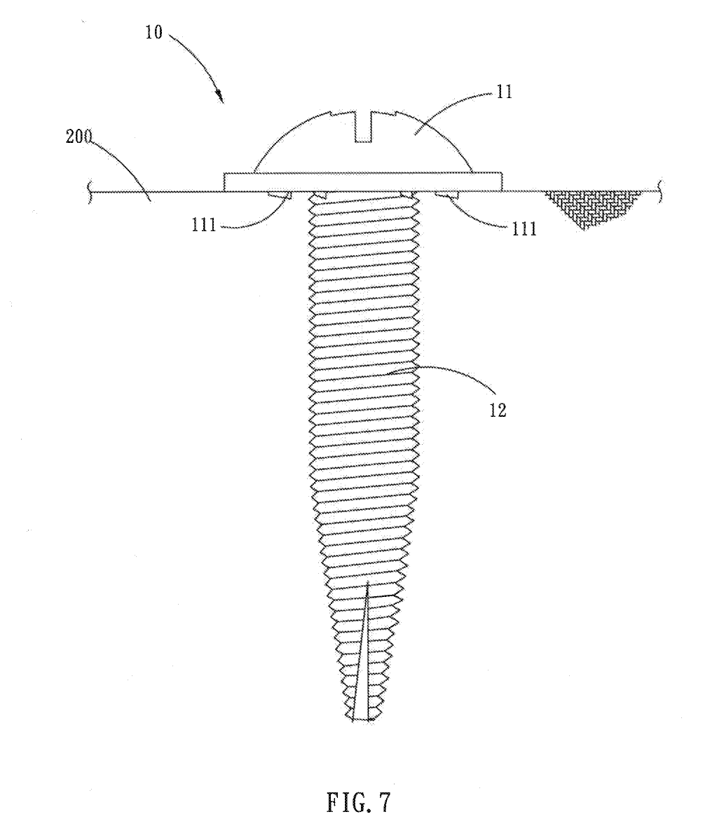

FIG. 7 shows a first application example of the fastening assembly 100 (as shown in FIG. 10) of the present invention. Referring to FIG. 7, a single fastening screw 10 is fastened with a work piece 200. The screw fastening section 12 at the lower portion of the fastening screw 10 is a self-tapping screw rod. By directly fastening the screw fastening section 12 into the work piece 200, the first tooth elements 111 at the lower surface of the head section 11 of the fastening screw 10 are screwed into an upper surface of the work piece 200. As such, the upper and lower portions of the fastening screw 10 are respectively closely screwed and fastening at an interior and a surface of the work piece 200. Further, as the first tooth elements 111 are one-directional thorn teeth, the screw fastening section 12 of the fastening screw 10 is allowed with only one-directional fastening without concerns of disengagement in an opposite direction.

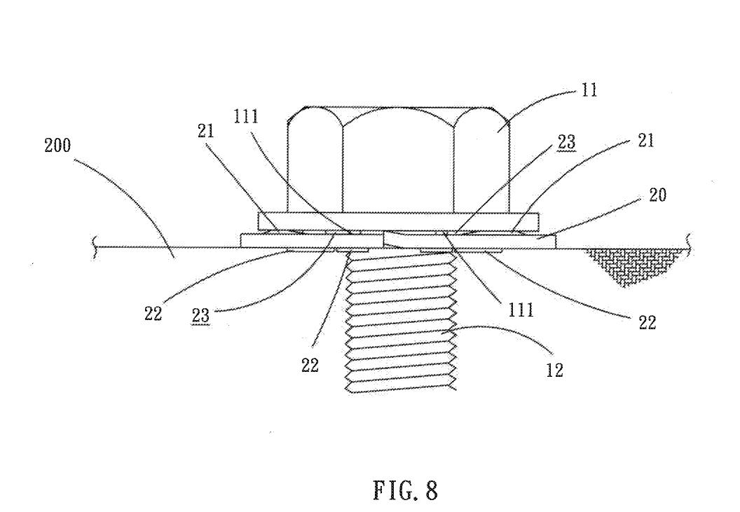

FIG. 8 shows a second application example of the fastening assembly 100 (as shown in FIG. 10) of the present invention. Referring to FIG. 8, the fastening screw 10 coordinating with the fastening accessory 20 is fastened to a work piece 200, with the fastening accessory 20 accommodated around the screw fastening section 12 at the lower portion of the fastening screw 10. After fastening the screw fastening section 12 into the work piece 200, by correspondingly lodging the first tooth elements 111 at the lower surface of the head section 11 of the fastening screw 10 into the embedding recess 24 (as shown in FIG. 3) at the upper surface of the fastening accessory 20, the fastening screw 10 is closely fastened with the fastening accessory 20, and the third tooth elements 22 of the fastening accessory 20 are correspondingly engaged with the upper surface of the work piece 200. As such, both of the fastening screw 10 and the fastening accessory 20 are fastened at the interior and the upper surface of the work piece 200.

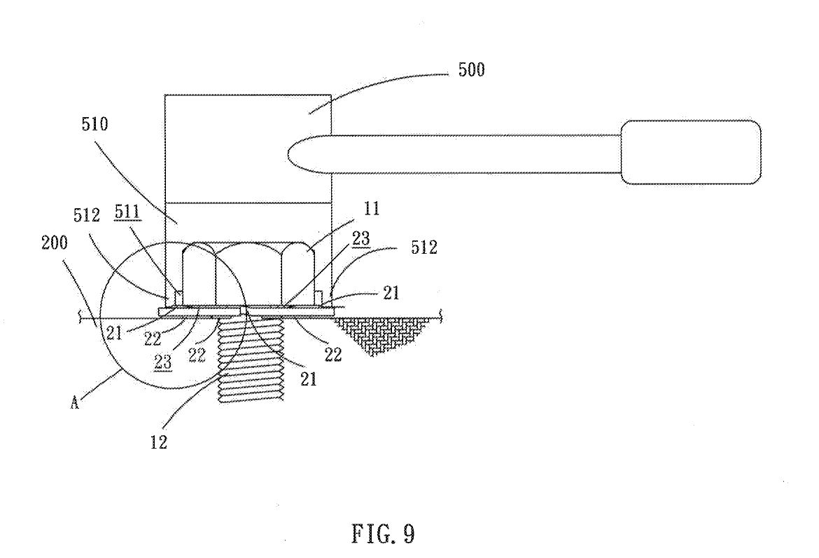

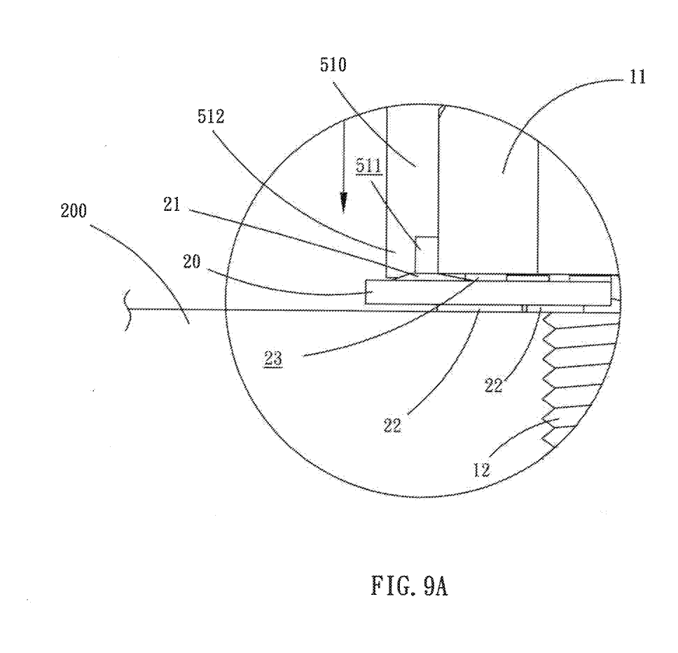

FIGS. 9, 9A and 10 shows a third application example of the fastening assembly 100 of the present invention. Referring to FIGS. 9 to 10, the head section 11 of the fastening screw 10 is disengaged by use of a disengaging socket wrench 500. The disengaging socket wrench 500 comprises a sleeve 510 at a front end thereof. The sleeve 510 is provided with a housing aperture 511 for correspondingly accommodating the head section 11 (as shown in FIG. 9) of the fastening screw 10. An outer periphery of a lower portion of the sleeve 510 is provided with at least one pair of claw pieces 512 for correspondingly pressing and engaging with the grooves 23 of the fastening accessory 20. To disengage the fastening screw 10, a force is downwardly applied through the sleeve 510 (as shown in FIG. 9A) to further propel the claw pieces 512 to downwardly press the fastening accessory 20, such that the first tooth elements 111 (as shown in FIG. 6) of the fastening screw 10 are detached from the embedding recess 24 (as shown in FIG. 3) of the fastening accessory 20. The fastening screw 10 is then rotated in an opposite direction to the screw direction of the screw fastening section 12 of the fastening screw 10 (as shown in FIG. 10) to remove the fastening screw 10 from the work piece 200. Similarly, when the fastening screw 10 is independently fastened to the work piece 200, the fastening screw 10 may be removed from the work piece 200 through the above operations of the disengaging socket wrench 500.

While the fastening assembly 100 of the invention has been described by way of example and in terms of the preferred embodiments with references to FIGS. 1 to 11, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A fastening assembly, comprising:
at least one fastening screw, comprising a head section having a plurality of first tooth elements at a lower surface thereof, and a screw fastening section at a lower portion thereof for fastening to an interior of a work piece; and
at least one fastening accessory, comprising a plurality of second tooth elements and a plurality of third tooth elements at upper and lower surfaces thereof, respectively; a plurality of grooves formed between the second tooth elements, and an embedding recess formed at an upper portion of the fastening accessory thereof;
wherein, the fastening accessory is accommodated around the screw fastening section at the lower section of the fastening to embed the head section of the fastening screw into the embedding recess at the upper portion of the fastening accessory; the first tooth elements are correspondingly lodged into the embedding recess of the fastening accessory to closely fasten the fastening accessory to the lower portion of the head section of the fastening screw; and the third tooth elements are engaged at an upper surface of the work piece to fasten the fastening accessory to the work piece, thereby forming a dual screw fastening structure with the fastening screw at the interior and at the upper surface of the work piece.

2. The fastening assembly according to claim 1, wherein the first tooth elements of the fastening screw are one-directional thorn teeth.

3. The fastening assembly according to claim 1, wherein the fastening accessory is a washer.

4. The fastening assembly according to claim 1, wherein the second tooth elements and the third tooth elements of the fastening accessory are one-directional thorn teeth.

5. The fastening assembly according to claim 1, wherein spaces between the second tooth elements and the grooves are formed by a stamping fracture process.

6. The fastening assembly according to claim 1, wherein the head section of the fastening screw is for removing the fastening screw by utilizing a disengaging socket wrench.

7. The fastening assembly according to claim 6, wherein the disengaging socket wrench comprises a sleeve at a front end thereof, and the sleeve is provided with an accommodating aperture therein for accommodating around the head section of the fastening screw.

8. The fastening assembly according to claim 6, wherein the disengaging socket wrench comprises at least one pair of claw pieces at an outer periphery at a lower portion thereof.

9. The fastening assembly according to claim 1, wherein the screw fastening section of the fastening screw is a self-tapping screw rod.
